(19) United States
(12) Patent Application Publication
(10) Pub. No.: US 2009/0185469 A1
(43) Pub. Date: Jul. 23, 2009

(54) DEVICE, SYSTEM AND METHOD FOR AUTOMATIC DATA SOLIDIFICATION

(76) Inventor: Juan Wang, San Jose, CA (US)

Correspondence Address: CHENGYUN GAO, 1136 SHAKER CT., SAN JOSE, CA, 95120, US

(21) Appl. No.: 12/016,311

(22) Filed: Jan. 18, 2008

(51) Int. Cl. G11B 7/28

(52) U.S. Cl. 369/85

(57) ABSTRACT

A device, system and method is invented to solidify data from temporary storage media to long term storage media without intervention of computer. Those who can not access computer are enabled to use digital recording apparatus, such as digital camera. The operation of the device is restricted in order to increase the ease of use, and to provide the core function. The core function is to read data from temporary storage media, such as various memory cards, and write the data to long term storage media, such as user-writeable CD or DVD. The device features a minimal set of hardware components for accomplishing this function, such as a simplified user interface, an embedded processor, a data reading channel, and a data solidification channel. A data play mode can also be optionally implemented for the user to check the solidified data.

### FIELD OF THE INVENTION

The present invention relates to a device, system and method for automatic data solidification from temporary data storage media to long term data storage media without intervention of a computer, and in particular, for such a device, system and method in which data solidification is performed with a highly simplified user interface.

### BACKGROUND OF THE INVENTION

Digital recoding apparatus, such as digital cameras for example, are popularly accepted by consumers nowadays. Many digital recoding apparatus use NAND flash based non-volatile storage media, such as SD (Secure Digital) card, MMC (Multimedia Card), to store the recorded pictures, video and audio data. These NAND flash based non-volatile storage media are compact and expensive. Though they are capable of storing data for long term, they are usually used as temporary storage media instead of long term storage media due to the large amount of data to store and their high cost. The long term data storage media should be non-volatile and be able to store large amount of data with low cost. The most frequently used long term storage media nowadays include, but not limited to CD (Compact Disk) and DVD (Digital Video Disk).

The user of the digital recording apparatus needs to transfer the data recorded on the expensive temporary storage media to low cost long term data storage media after certain amount of data have been recorded. The procedure to transfer the data from the temporary storage media to long term storage media is called solidification. State-of-the-art data solidification is typically performed in two steps with the intervention of a computer. The first step is to transfer the data from the short term data storage media to a computer through a data transfer interface supported by the digital recording apparatus and the computer, wherein the short term data storage is attached to the computer through the digital recording apparatus as a massive storage of the computer. The data transfer interface can be a USB (Universal Serial Bus) link or wireless link. The user can also optionally remove the short term data storage media from the digital recording apparatus and attach it to the computer through a card reader on computer or an external card reader. The second step is to further transfer the data from the computer to low cost long term data storage media through a peripheral of the computer, such as a DVD writer for example.

A computer has the advantage of being able to read, write, store, manipulate and playback the data. But a computer suffers from its complexity to operate, high price and availability in certain circumstances. The present invention enables the user of the digital recording apparatus to overcome the said drawbacks of the computer for solidifying data from temporary data storage media to long term data storage media without intervention of a computer. It also enables those who can not use computer or do not have computer to be able to use digital recording apparatus.

### SUMMARY OF THE INVENTION

The present invention overcomes the drawbacks of the background art, by providing a device, a method and a system for data solidification to bypass the intervention of a computer. The operations of the device are restricted, in order to increase the ease of use of the device, and in order to provide certain core functions. These core functions include solidifying data from the temporary data storage media to long term data storage media, and checking the solidified data. The device preferably has a limited device interface, which is optionally and more preferably only able to interact with the temporary storage media and the long term storage media according to the present invention. The device preferably has a display panel for the user to play and check the solidified multimedia data. Alternatively, a limited user interface is provided, for example in order to permit the user to choose the data to check or to set the number of solidification copies. According to a preferred embodiment of the present invention, the device automatically enters solidification mode when the connected long term storage media is user-writeable and initially empty; or it enters play mode when the long term storage media is initially not empty, for the user to play and check the data solidified on the long term storage media. Optionally two buttons can be provided for the user to choose the previous or next data to play in the play mode; or to increase or decrease the number of solidification copies in solidification mode.

### BRIEF DESCRIPTION OF THE DRAWING

The foregoing summary, as well as the following detailed description of preferred embodiments, is better understood when read in conjunction with the appended drawings. For the purpose of illustrating the invention, there is shown in the drawing exemplary constructions of the invention; however, the invention is not limited to the specific methods and implementations disclosed. In the drawings:

FIG. 1 is the automatic data solidification device 100 of present invention in data solidification mode, in communication with a digital camera 200 with temporary data storage media inside and a CD 300 which is user writeable and initially empty.

FIG. 2 is the automatic data solidification device 100 of present invention in data play mode, in communication with a CD 300 which initially contains solidified data.

FIG. 3 is a schematic block diagram of an illustrative system and device according to the present invention, in communication with a digital camera 200 with temporary data storage media inside and a CD 300. The temporary data storage media is inside the digital camera 200 and it is not shown in the drawing. The automatic data solidification device 100 is comprised of controller 102, memory 104, display 106, user interface 108, USB host 112, data decoder 114, and DVD reader/writer 116. The CD 300 can be inserted into the DVD reader/writer 116. The link 118 shows the logic data access path between the CD 300 and the DVD reader/writer 116. The digital camera 200 is connected to the USB host 112 through USB cable 202. The system bus 110 connects all the components to form the device. The system bus 110 most preferably includes control potion and data potion.

### DETAILED DESCRIPTION OF THE INVENTION

The present invention is of a device, a method and a system for automatic data solidification most preferably for digital recording apparatus through a simplified device interface. The operations of the device are restricted, in order to increase the ease of use, and provide core functions. The detailed core functions include detecting the attachment of the temporary storage media, reading data from the temporary storage media, removing data from the temporary storage media, detecting the presence of the long term storage media, reading data from the long term storage media and writing data to the long term storage media, as well as optionally decoding and displaying the data read from the long term storage media.

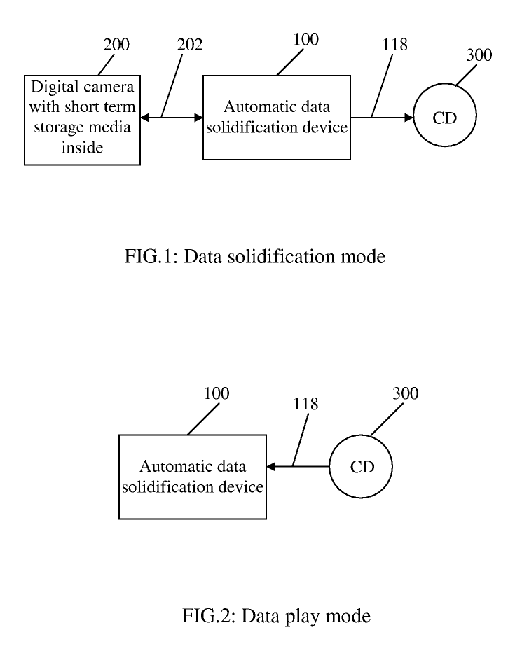

Referring to the drawings, FIG. 1 shows an automatic data solidification device according to present invention working in data solidification mode. When a user-writeable empty CD 300 is inserted into the automatic data solidification device 100, the device 100 can detect if the CD 300 is empty. If the CD is empty, it suggests the user's intention to transfer data from the temporary data storage media inside the digital camera 200 to the CD 300 through the automatic data solidification device 100 according to present invention. The automatic data solidification device 100 enters data solidification mode without user intervention. When a digital camera 200 with temporary data storage media inside is electrically connected to the automatic data solidification device 100, the automatic data solidification device 100 can detect the attachment and then starts to read data from the temporary storage media inside the digital camera 200 and write the data to the CD 300. The user can also connect the digital camera 200 to the automatic data solidification device 100 before the CD 300 is inserted. The automatic data solidification device 100 will not change mode or start any data transfer operation before the CD 300 is inserted into the device 100. The connection order of digital camera 200 with temporary storage media and CD 300 will not affect the data solidification result. The automatic data solidification device 100 should optionally and more preferably set a default number of solidification copies of 2 after power on. The user can further optionally use the simplified user interface of the automatic data solidification device 100 to increase or decrease the number of copies of CD. After the specified copies of CD have been made, the solidified data in the temporary storage media inside the digital camera 200 can be deleted to make space for further use of the digital camera 200. The automatic data solidification device 100 can optionally and more preferably prompt the user before it deletes the data in the temporary storage media inside the digital camera 200, and the user can confirm the deletion through the simplified user interface on the automatic data solidification device 100.

FIG. 2 shows an automatic data solidification device 100 according to present invention working in data play mode. When a CD 300 containing existing data is inserted into the automatic data solidification device 100, the automatic data solidification device 100 can detect the existing data on the CD 300 and enters data play mode without user intervention. The automatic data solidification device 100 can optionally and more preferably choose to play the first data on the CD 300. The user can optionally use the simplified user interface of the automatic data solidification device 100 to choose the previous or the next multimedia data to play. This data play mode enables the user to check the solidified data.

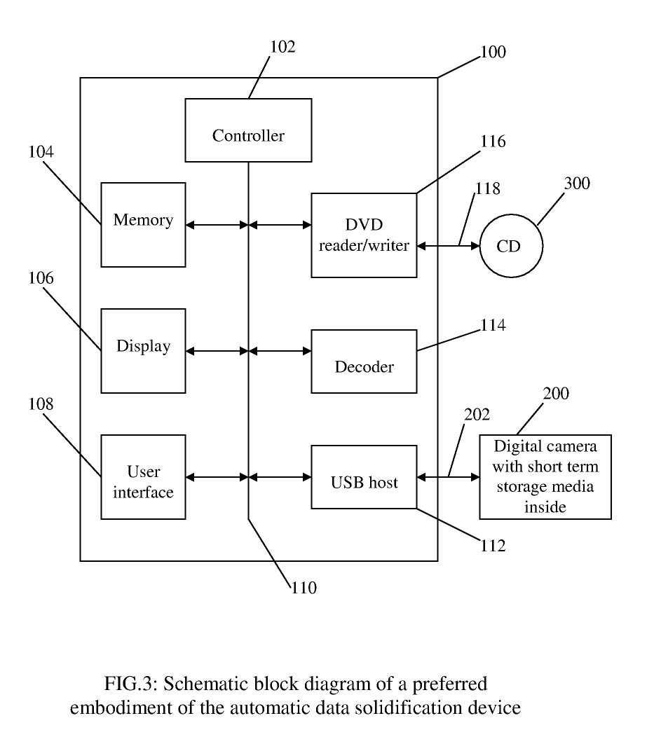

FIG. 3 shows the schematic block diagram of a preferred embodiment of the present invention, in communication with a CD 300 and a digital camera 200 with temporary storage media inside. The automatic data solidification device 100 of present invention consists of a controller 102, a DVD reader/writer 116, a decoder 114, a USB host 112, a memory block 104, a display 106 and a user interface 108 connected together with system bus 110.

The USB host 112 is used to read data from the temporary storage media inside the digital camera 200 though a USB cable 202. The USB host 112 can also be used to delete data on the temporary storage media inside the digital camera 200 and detect the attachment of the digital camera 200 through the USB cable 202 according to the background art. The USB host 112 can also optionally connect to a card reader with USB device interface to access various temporary storage media. The automatic data solidification device 100 can also optionally implement a card reader to access various temporary storage media directly. This is not shown in FIG. 3 in order to simplify the drawing.

The DVD reader/writer 116 can be used to read and write the long term storage media, including but not limited to CD and DVD. A CD 300 is used for illustration purpose in the preferred embodiment of present invention. The connection 118 between the DVD reader/writer 116 and the CD 300 is the logic data transfer path for demonstration purpose. The CD 300 is physically inserted into the DVD reader/writer 116 directly.

The memory 104 is a storage module for the automatic data solidification device 100 according to present invention. The memory 104 can be used to store the instructions for the controller 102, temporarily store the data to be solidified in data solidification mode or temporarily store the data to be played in data play mode, or for any other occasions that need internal storage space. The memory 104 may optionally consist of multiple memory formats or modules.

The decoder 114 is used to convert the encoded multimedia data read from the CD 300 into format that can be displayed on the display 106. The display 106 can be used to visually display the decoded media data in play mode, and display information to guide the user to operate the device 100.

The user interface 108 implements a simplified and restricted interface for the user to operate the automatic data solidification device 100 according to present invention. The user interface for the device 100 is simplified and restricted to improve the ease of use of the device 100. The user interface can be optionally and preferably as simple as, but not limited to two buttons. One button is optionally and preferably used to choose the previous data to play in data play mode, and optionally to increase one solidification copy in data solidification mode; another button is used to choose the next data to play in data play mode, and optionally to decrease one solidification copy in data solidification mode. These two buttons can also be optionally used to confirm the deletion of the data on the temporary data storage inside the digital camera 200 after the specified CD copies have been made and the device 100 prompts the user to confirm data deletion.

The controller 102 controls the overall working flow for the automatic data solidification device 100. It can optionally and preferably be an embedded microprocessor.

The bus 110 connects all modules together to form the automatic data solidification device 100 according to present invention. It optionally and more preferably contains a control potion and a data transfer potion.

When the user intends to transfer data from the temporary storage media inside the digital camera 200 to a CD 300, a user-writeable empty CD 300 is inserted into the DVD reader/writer 116. The controller 102 will detect the presence of CD 300 optionally by means of interrupt or inquiry, and read the CD 300 through the CD reader/writer 116 and further decides the type and capacity of the CD 300. If the controller 102 decides the CD 300 is an empty and user-writeable disk, the automatic data solidification device 100 shall enter data solidification mode. Then the controller 102 checks if a temporary storage media is attached to the USB host 112 either through a digital camera 200 or a card reader. If an optional card reader/writer is implemented in the automatic data solidification device 100, the controller shall also check the card reader/writer for data source. The optional card reader/writer is not shown in the drawing to simplify the drawing. If a digital camera 200 with temporary storage media inside is detected, the controller 102 can further check the data size on the digital camera 200 through the USB host 112. The data size to be solidified can not exceed the capacity of the empty CD 300. The excessive data on the temporary storage media will not be processed by current data solidification procedure. The user can optionally and preferably process the residual data in the future. The controller 102 then starts the data solidification procedure until the specified CD copies have been completed. The user can optionally leave the number of copies to the default value of 2, or the number of copies can be increased or decreased through the simplified user interface 108 in the data solidification mode. The controller 102 can then optionally prompt the user through the display 106 to delete the data on the temporary storage media that has been solidified and the user can confirm through the simplified user interface 108. The user can further use the digital camera 200 after the temporary storage media is partly or completely emptied.

When the user intends to play or check the solidified data, the user can optionally insert the CD with existing data into the DVD reader/writer 116. The controller 102 will read the CD 300 through the CD reader/writer 116 and further decides the type and capacity of the CD 300. If the controller 102 decides the CD 300 is not empty, the automatic data solidification device 100 shall enter the data play mode. The DVD reader/writer 116 reads a block of data from the CD 300 through the DVD reader/writer 116 to the memory 104. The controller 102 can optionally control the decoder 114 to decode the data and send the decoded data to the display 106. The user can now view the decoded data on the display 106. The user can optionally choose the previous or the next data to play with the simplified user interface 108.

Those who can not access a computer or do not have a computer is now enabled to use digital camera with the help of the automatic data solidification device 100 according to present invention.

What is claimed is:

1. A device for automatic data solidification, which transfers data from temporary data storage media to long term data storage media without intervention of a computer, comprising: (a) A simplified user interface; (b) An interface to temporary data storage media for reading data and manipulating data on the temporary data storage media; (c) An interface to long term data storage media for detecting the presence, type and capacity of the long term data storage media, and accessing the long term data storage media; (d) A controller for controlling the data transfer procedure.

2. The device of claim 1, wherein the temporary data storage media is NAND flash based non-volatile memory.

3. The device of claim 1, wherein the long term data storage media is user-writeable CD or DVD.

4. The device of claim 1, wherein the interface to the temporary data storage media is an indirect interface, which accesses the temporary storage media attached to an external card reader, or a digital recording apparatus through a cable or wireless link.

5. The device of claim 1, wherein the interface to the long term data storage media is an indirect interface, which accesses the long term storage media attached to an external reader/writer through a cable or wireless link.

6. The device of claim 1, comprising an additional data decoding function and a display panel for playing and checking the solidified data on the long term data storage media. The device can optionally enter data solidification mode or data play mode without user intervention by judging the type of the long term storage media.
